(19) United States
(12) Patent Application Publication
(10) Pub. No.: US 2011/0049027 A1
(43) Pub. Date: Mar. 3, 2011

(54) Storm Drain Protector

(76) Inventor: John Rueda, Elk Grove, CA (US)

(21) Appl. No.: 12/869,473

(22) Filed: Aug. 26, 2010

Related U.S. Application Data
(60) Provisional application No. 61/237,230, filed on Aug. 26, 2009.

(51) Int. Cl. E03F 5/06; B23P 17/04

(52) U.S. Cl. 210/163; 29/428

(57) ABSTRACT

A storm drain protector with a top layer having a generally horizontal surface in which there is at least one hole that allows water to pass vertically through the surface. The horizontal surface also has several vertical projections emanating from the surface that permit the passage of water over the surface while impeding the passage of debris.

### REFERENCE TO RELATED APPLICATION

This application claims the benefit of U.S. Provisional Patent Application No. 61/237,230, filed Aug. 26, 2009, the disclosure of which is incorporated herein.

### BACKGROUND OF THE INVENTION

1. Field of the Invention

This invention describes a storm drain protector used to filter storm water runoff of sediment and other debris so that such materials do not clog the drain, hinder flow or pollute the body of water to which such drains ultimately flow.

2. Description of Related Art

Storm drains, commonly located in roadways, parking lots or beside sidewalks, are ordinarily covered by a simple metal grating that serves the dual purpose of preventing large debris from entering the drain and providing a barrier for pedestrians and animals. Such a grating does not filter anything but the largest of debris and is easily clogged when such large materials amass and cover the opening. Where there is a potential for large amounts of sediment or debris being washed into the drain, such as near a construction site, there exists a need for additional protection and filtration for the storm drain. This need is augmented by the fact that runoff water is often directly channeled to the ocean or other public bodies of water. Public safety and recent environmental regulation prohibiting the contamination of such resources, now requires that water entering storm drains not be polluted.

Numerous products have been used to prevent sediment or other materials from flowing into storm drains in such situations. U.S. Pat. No. 7,481,921, granted to Kent on Jan. 27, 2009, discloses a cleanable and reusable fibrous mat adapted to filter water that is placed over the top of a preexisting grating on a storm drain. Unfortunately, storm drains are subject to variable flow rates, with very high rates being common. Although the Kent apparatus succeeds in preventing the passage of sediment and small debris that would otherwise bypass the grating, it is likely that such a fibrous mat would need to be continuously cleaned and would quickly clog in high flow situations or if left untended for any significant period of time. Moreover, the Kent apparatus provides no method of filtering liquid contaminants, such as motor oil, that may commonly find their way to storm drains.

Another type of storm drain filter device is disclosed in U.S. Pat. No. 7,156,987, issued to Sanguinetti on Jan. 2, 2007. Sanguinetti describes a flexible, frameless filter bag. In this system, the metal storm drain grating is removed and placed into a filter bag capable of filtering in-flowing water. The grating, now wrapped in the bag, is then placed back into the drain. The bag is removed and emptied when it becomes filled with silt and debris. While the Sanguinetti device addresses the need to make such devices easily cleaned and installed, as with Kent, the Sanguinetti device has the disadvantage that it quickly becomes clogged and must be continuously cleaned to maintain flow into the drain. Kent also does not address the problem of potential liquid pollutants.

As is shown by the foregoing art, despite a long felt need, none of the prior approaches to preventing sediment and debris from entering storm drains have been able to effectively filter such materials in a way that prevents the filtering apparatus from quickly becoming clogged in high flow situations. Moreover, none of the prior approaches has been effective in substantially preventing liquid pollutants, such as motor oil, from passing into storm drains.

### SUMMARY OF THE INVENTION

This invention provides a storm drain protector with a top layer having a generally horizontal surface in which there is at least one hole that allows water to pass vertically through the surface. The horizontal surface also has several vertical projections emanating from the surface that permit the passage of water over the surface while impeding the passage of debris.

In various alternative embodiments, the first layer is square, rectangular, circular, oval or is of a shape intended to fit a curbside drain. In the latter configuration, the protector has a substantially vertical surface that is contiguous with the horizontal surface. In still further embodiments, the hole has edges that protrude above the horizontal surface, there is more than one hole, there is a central hole having a diameter of at least about four inches. Another embodiment would have at least one depression in the horizontal surface.

Other possible embodiments include the addition of a screen layer that allows the passage of water through the hole but impedes the passage of debris. In another embodiment, this screen layer is affixed beneath the first layer or is fastened to the first layer through any suitable method known to the art, such as sewing, stapling, gluing or fusing. The screen layer may also be a mesh and that mesh has openings of at least about an eighth of an inch.

In another preferred embodiment, the storm drain protector has a water permeable layer, which can be formed of a matted material, such as felt. The water permeable layer may, alternatively, be water permeable foam. A water permeable layer may be employed that absorbs, binds, or otherwise impedes the passage of hydrocarbons with the drain water. Such a layer may also be fastened to the first layer through various means, including sewing, stapling, gluing or fusing.

In one embodiment, the first layer is manufactured by stamping, molding or extruding. In another, it is made of rubber or of a synthetic plastic. The projections are preferrably at least about one-half of an inch or, in a different embodiment, at least about three-quarters of an inch in height. In another embodiment the projections are conical, though in a separate embodiment they are cylindrical.

In a preferred embodiment, the projections are regularly spaced over the horizontal surface and where so spaced, they are preferably about one-half inch apart, though greater or lesser distances may be preferred, depending on the usage and type of debris.

Alternatively, the projections may be randomly or irregularly spaced along the horizontal surface.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 shows a perspective view of a first embodiment of the invention with layers separated.

FIG. 2 is a perspective view of the top layer of the first embodiment of the invention, including a close-up view.

FIG. 3 depicts a perspective view of the first embodiment of the invention in use.

FIG. 4 shows a close-up view of the top layer of a second embodiment, including a cut-away view.

FIG. 5 is a perspective view of the top layer of a third embodiment.

FIG. 6 shows a perspective view of a variation of prior embodiments in place on a storm drain.

### DETAILED DESCRIPTION OF THE INVENTION

The invention provides for a storm drain protector formed of a first, or top, layer forming a horizontal surface with a series of vertical projections and perforations, or holes, through which drain water can flow. The vertical projections of the top layer allow the passage of water over the surface, but are designed to create a barrier that prevents debris carried with the drain water from entering onto the surface and clogging the drain holes.

The storm drain protector includes a screening layer of fine pore filtering material able to trap larger sediment or other solid debris, and may include a layer of material able to filter out even finer sediment, and possibly forming a barrier to the passage of liquid hydrocarbons.

Vertical depressions in the surface are designed to trap sediment so as to prevent them from building up in the fine pores and, likewise, clogging the drain.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any materials similar or equivalent to those described herein can also be used in the practice or testing of the present invention, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention.

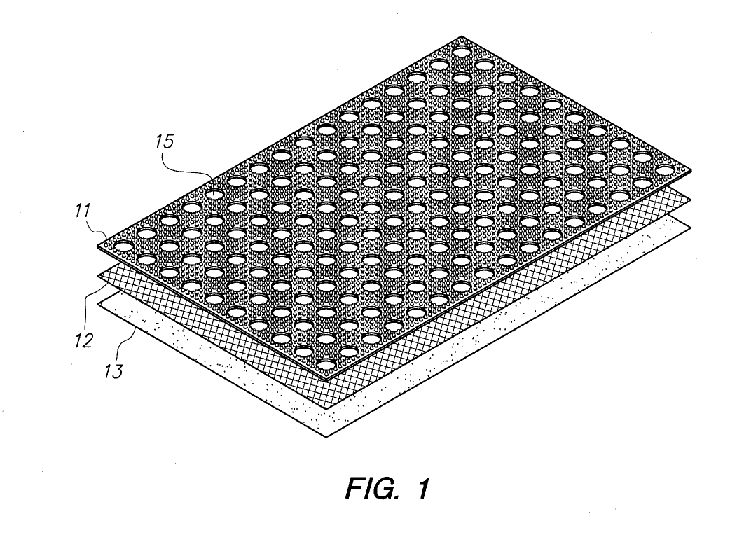

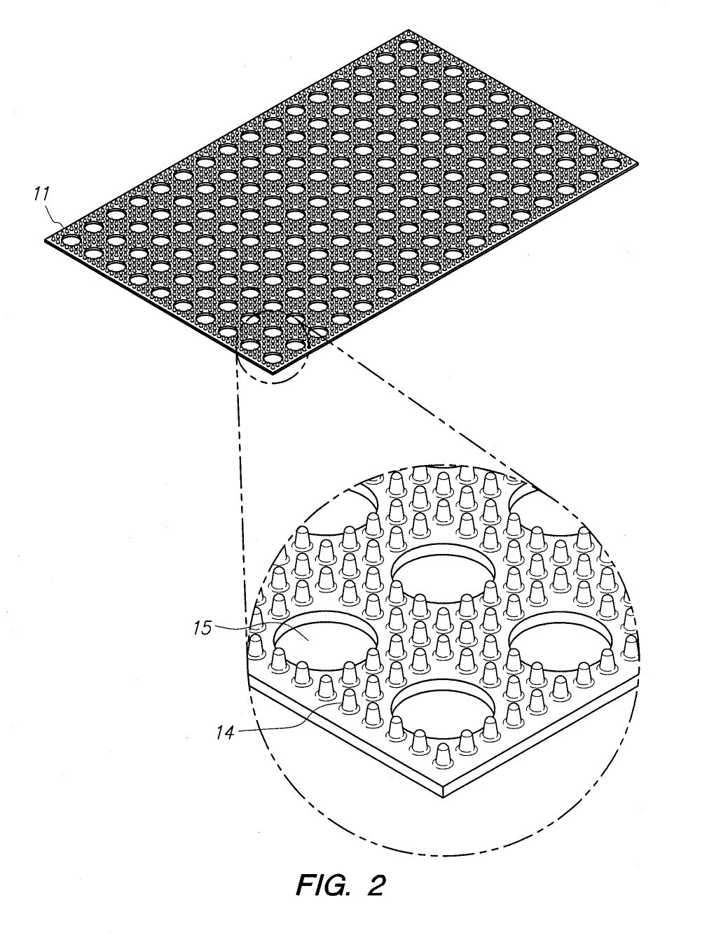

In a first embodiment, as shown in FIG. 1, the storm drain protector is rectangular and has three layers 11, 12, 13. The first or top layer 11, as shown in FIG. 2, is a rubber or extruded plastic mat having small (approximately a half inch tall) projections 14 and perforations 15 (approximately a half inch wide) over its entire surface area. The second or center layer 12 is composed of a screen or mesh, having apertures of approximately one-eighth of an inch or greater. The third or bottom layer 13 is composed of a lightweight and very dense felt material, having hydrophobic properties. These three layers are sewn together at the edges or otherwise fastened together and act as a single barrier that is laid over the conventional metal grating of a storm drain.

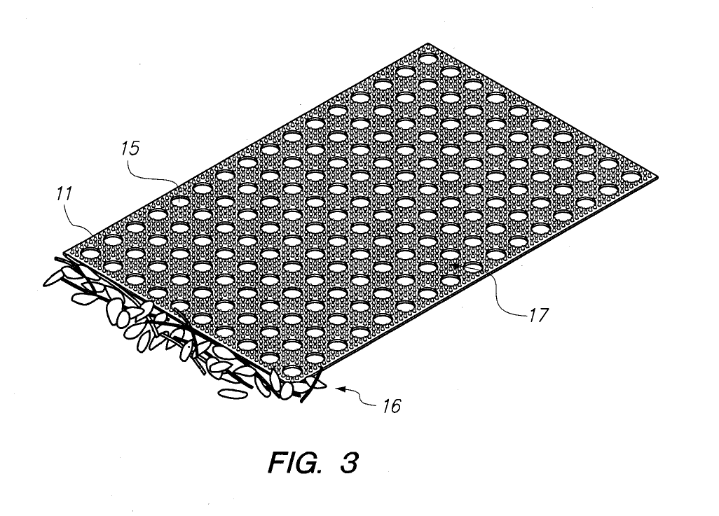

In operation, as shown in FIG. 3, water, having debris and sediment, flows horizontally toward the protector. Upon encountering the protector's edge, large debris and sediment 16 is blocked from moving horizontally over the top surface 17 of the mat by the projections 14. Water, meanwhile, continues the flow through and over the blocked debris, over the top of the mat and through the perforations 15 in the center of the mat. Eventually, the debris and sediment 17 at the edges of the protector builds up and provides a further barrier to additional debris flowing toward the protector. Periodically, such debris may be removed with a rake using a similar method. Advantageously, and unlike prior attempted solutions, this design allows the protector to stop large debris before it arrives at the perforations 15 preventing these perforations 15 from being blocked and the protector clogged. Moreover, as opposed to a design in which water might enter a drain horizontally, in this design, much of the debris is stopped while it is slowly moving in a horizontal direction, allowing gravity to assist in the blocking of debris. Yet water still enters the drain vertically, allowing gravity to speed the flow.

Water passing through the perforations may contain debris and sediment small enough to flow with the water past the projections 14. The second screen layer 12 filters such materials while allowing water to pass through. Finally, the bottom layer 13 is intended to allow water to pass but provides a barrier to oils and other non-water soluble liquid contaminants.

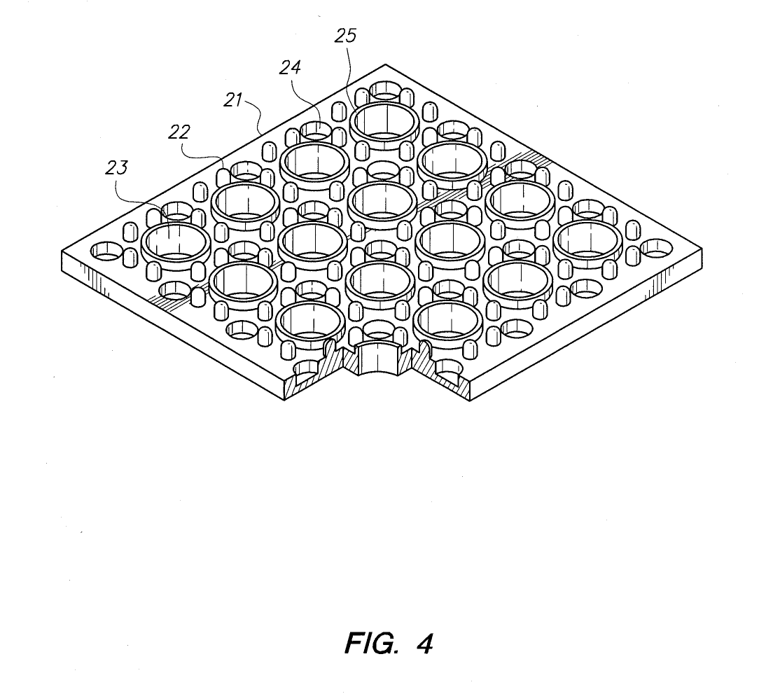

In a second embodiment, shown in FIG. 4, in addition to the top layer having small projections 22 and perforations 23, the mat also has small (approximately half inch wide) depressions 24. These depressions 24 serve as a trap into which may fall medium sized sediment particles that would otherwise flow through the perforations 23 and be filtered out by the middle or bottom layer. It is advantageous to trap such material on the surface of the mat so that it does not impede the flow of water through the other layers.

This embodiment also shows the perforations having an edge 25 that projects above the flat surface of the top layer 21. The edge 25 forms a further barrier to fine debris or sediment flowing into the perforations 23.

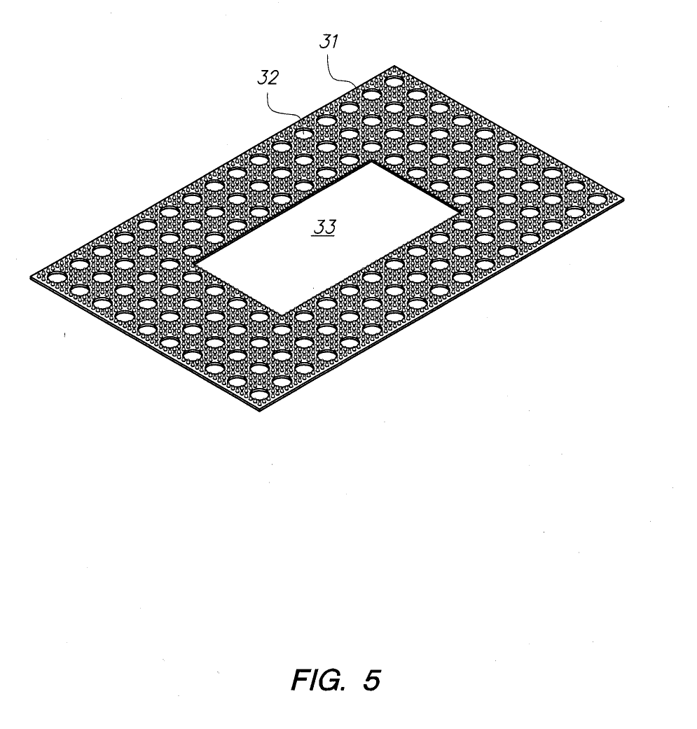

In the embodiment shown in FIG. 5, in addition to or in place of the multiple perforations 32 of the top layer 31, there is a large hole 33 in the top layer 31 at or near its center that is of relatively greater size, i.e., greater that four inches across. Such an embodiment is advantageous in high water flow situations where the small perforations of other embodiments would not provide a sufficient flow rate through the storm drain protector.

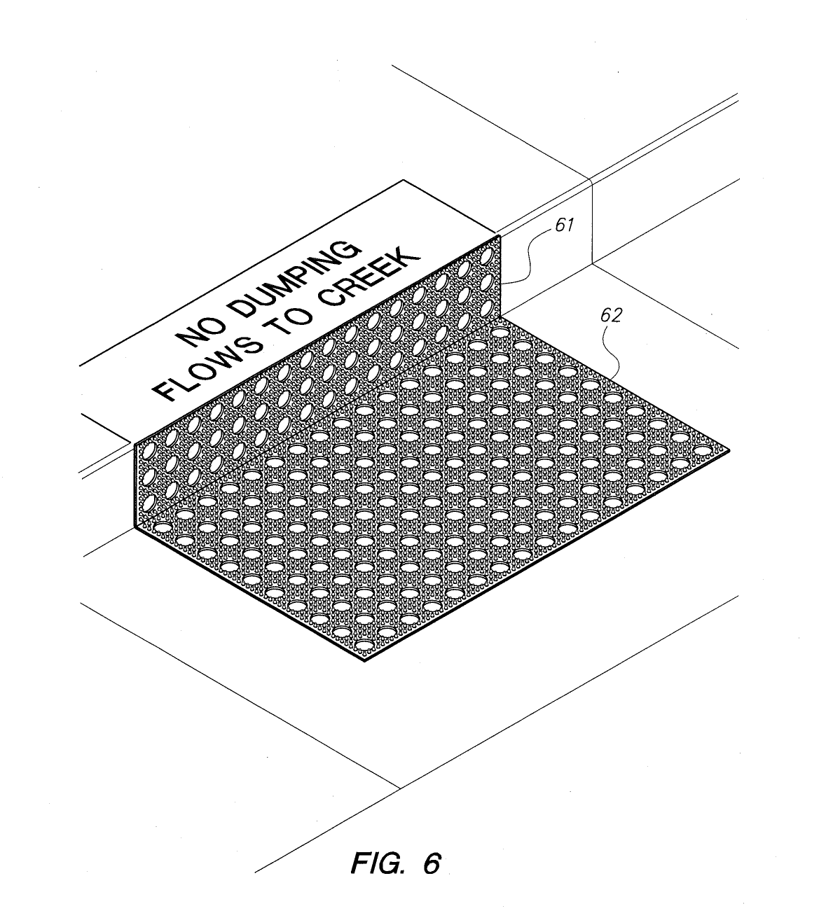

In addition to these embodiments, the invention contemplates additional variations upon these embodiments, including various different rectangular sizes and circular versions, also of different diameters. These variations are sized to allow slightly overlapping coverage of storm drains having various shapes and sizes. Another variation, shown in FIG. 6, is one composed of two flat surfaces 61, 62 perpendicularly joined so as to fit over a curbside drain.

The invention also contemplates different layers depending on the likely contaminants of the runoff water at a particular location. Such layers could include a water permeable filter, such as a charcoal filter, and a synthetic foam rubber filter. Such layers may be grouped in any combination that is appropriate given the nature of the potential contaminants, the level of filtering that is deemed necessary and the expected flow rate.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A storm drain protector having a first layer comprising a generally horizontal surface having at least one hole formed therein, and a plurality of substantially vertical projections emanating from said horizontal surface, wherein said hole allows passage of water vertically through said first layer, and wherein said vertical projections permit passage of water over said horizontal surface while impeding passage of debris.

2. The storm drain protector of claim 1 wherein said first layer has a shape selected from the group of shapes consisting of square, rectangular, circular and oval.

3. The storm drain protector of claim 1 wherein said first layer has a shape configured to fit a curbside storm drain.

4. The storm drain protector of claim 3 further comprising a substantially vertical surface contiguous with said horizontal surface.

5. The storm drain protector of claim 1 wherein said hole comprise edges protruding above said horizontal surface.

6. The storm drain protector of claim 1 having a plurality of holes formed in said first layer.

7. The storm drain protector of claim 6 having a central hole with a diameter of at least about four inches.

8. The storm drain protector of claim 1 further comprising at least one depression formed in said horizontal surface.

9. The storm drain protector of claim 1 further comprising a screen layer allowing passage of water through said hole while impeding passage of debris

10. The storm drain protector of claim 9 wherein said screen layer is affixed beneath said first layer.

11. The storm drain protector of claim 10 wherein said screen layer is fastened to said first layer through a manufacturing process selected from the group of processes consisting of sewing, stapling, gluing and fusing.

12. The storm drain protector of claim 9 wherein said screen layer is a mesh.

13. The storm drain protector of claim 12 wherein said mesh comprises openings of at least about an eighth of an inch.

14. The storm drain protector of claim 1 further comprising a water permeable layer.

15. The storm drain protector of claim 14 wherein said water permeable layer is formed of matted material.

16. The storm drain protector of claim 15 wherein said matted material comprises felt.

17. The storm drain protector of claim 14 wherein said water permeable layer comprises a water permeable foam.

18. The storm drain protector of claim 14 wherein said water permeable layer impedes the passage of hydrocarbons.

19. The storm drain protector of claim 14 wherein said water permeable layer is fastened to said first layer through a manufacturing process selected from the group of processes consisting of sewing, stapling, gluing and fusing.

20. The storm drain protector of claim 1 wherein said first layer is formed through a manufacturing process selected from the group of processes consisting of stamping, molding and extruding.

21. The storm drain protector of claim 20 wherein said first layer comprises rubber.

22. The storm drain protector of claim 20 wherein said first layer comprises a synthetic plastic.

23. The storm drain protector of claim 1 wherein said projections are at least about one-half of an inch.

24. The storm drain protector of claim 23 wherein said projections are at least about three-quarters of an inch.

25. The storm drain protector of claim 1 wherein said projections are conical.

26. The storm drain protector of claim 1 wherein said projections are cylindrical.

27. The storm drain protector of claim 1 wherein said projections are spaced regularly over said horizontal surface.

28. The storm drain protector of claim 27 wherein said projections are spaced at least about one-half inch apart.
